(19) United States
(12) Patent Application Publication
(10) Pub. No.: US 2026/0111656 A1
(43) Pub. Date: Apr. 23, 2026

(54) ELECTRONIC DEVICE AND METHOD FOR STRUCTURING TABLE IN ELECTRONIC DOCUMENT

(71) Applicant: SAMSUNG ELECTRONICS CO., LTD., Suwon-si (KR)

(72) Inventor: Jaewoo PARK, Suwon-si (KR)

(73) Assignee: SAMSUNG ELECTRONICS CO., LTD., Suwon-si (KR)

(21) Appl. No.: 19/284,033

(22) Filed: Jul. 29, 2025

Related U.S. Application Data
(63) Continuation of application No. PCT/KR2025/010461, filed on Jul. 16, 2025.

(30) Foreign Application Priority Data
Oct. 17, 2024 (KR) 10-2024-0142092
Nov. 19, 2024 (KR) 10-2024-0164752

(51) Int. Cl. G06F 40/177; G06V 30/19; G06V 30/412; G06V 30/413; G06V 30/414

(52) U.S. Cl. CPC G06F 40/177; G06V 30/19173; G06V 30/412; G06V 30/413; G06V 30/414

(57) ABSTRACT

An electronic device identify, from an electronic document, cell boxes included in a table and at least one text box included in the table, wherein each of the at least one text box includes text; allocate each of the at least one text box to a first corresponding cell box among the cell boxes, based on first coordinate information about the cell boxes and second coordinate information about the at least one text box; identify at least one boundary for separating rows or columns of the table, based on x-coordinates and y-coordinates in the first coordinate information about the cell boxes; modify the first coordinate information about the cell boxes, based on the at least one boundary; and reallocate each of the at least one text box to a second corresponding cell box among the cell boxes, based on the modified first coordinate information about the cell boxes.

### CROSS-REFERENCE TO RELATED APPLICATIONS

This application is a by-pass continuation application of International Application No. PCT/KR2025/010461, filed on Jul. 16, 2025, which is based on and claims priority to Korean Patent Application No. 10-2024-0142092, filed on Oct. 17, 2024, and Korean Patent Application No. 10-2024-0164752, filed on Nov. 19, 2024, in the Korean Intellectual Property Office, the disclosures of which are incorporated by reference herein their entireties.

### BACKGROUND

### 1. Field

The disclosure relates to an electronic device and method for structuring a table in an electronic document.

### 2. Description of Related Art

An electronic document may have a digital format on an electronic device such as a computer or a mobile device. The electronic document may be edited or read on the electronic device and may include various content such as text, images, or tables. In electronic documents, tables may be used to display summaries of information or data in a structured way. The tables include rows and columns, which may organize information or data systematically and facilitate visual analysis.

Recently, methods for table recognition (e.g., identification or determination) in electronic documents have been actively studied. Table recognition methods are continuously advancing through various technologies; however, no method has yet been proposed to measure or provide the confidence of table recognition results. For a recognized table to be utilized in critical decision-making or widely across various fields, its confidence, indicating its accuracy and dependability, may be required as a crucial factor.

The above-described information may be provided as related art for the purpose of helping understanding of the disclosure. The foregoing cannot be claimed as, or used to determine, the related art related to the disclosure.

### SUMMARY

Provided are an electronic device and a method for structuring a table in an electronic document.

Provided are an electronic device and a method for measuring the confidence of a table recognized (e.g., identified or determined) in an electronic document.

Provided are an electronic device and a method for providing structure confidence based on structuring a table in an electronic document.

Provided are an electronic device and a method for providing content confidence based on a table recognition (e.g., identification or determination) result in an electronic document.

According to an aspect of the disclosure, an electronic device includes: memory storing instructions; and at least one processor configured to execute the instructions, wherein the instructions, when executed by the at least one processor individually or collectively, cause the electronic device to: identify, from an electronic document, a plurality of cell boxes included in a table and at least one text box included in the table, wherein each of the at least one text box includes text; allocate each of the at least one text box to a first corresponding cell box among the plurality of cell boxes, based on first coordinate information about the plurality of cell boxes and second coordinate information about the at least one text box; identify at least one boundary for separating rows or columns of the table, based on a plurality of x-coordinates and a plurality of y-coordinates that are included in the first coordinate information about the plurality of cell boxes; modify the first coordinate information about the plurality of cell boxes, based on the at least one boundary; and reallocate each of the at least one text box to a second corresponding cell box among the plurality of cell boxes, based on the modified first coordinate information about the plurality of cell boxes.

According to an aspect of the disclosure, a method for operating an electronic device, includes: identifying, from an electronic document, a plurality of cell boxes in a table and at least one text box in the table, wherein each of the at least one text box comprises text; allocating each of the at least one text box to a first corresponding cell box among the plurality of cell boxes, based on first coordinate information about the plurality of cell boxes and second coordinate information about the at least one text box; identifying at least one boundary for separating rows or columns of the table, based on a plurality of x-coordinates and a plurality of y-coordinates that are included in the first coordinate information about the plurality of cell boxes; modifying the first coordinate information about the plurality of cell boxes, based on the at least one boundary; and reallocating each of the at least one text box to a second corresponding cell box among the plurality of cell boxes, based on the modified first coordinate information about the plurality of cell boxes.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example electronic device according to one or more embodiment(s);

FIG. 2A illustrates an example table structuring device according to one or more embodiment(s);

FIG. 2B illustrates an example coordinate information about each of a cell box and a text box according to one or more embodiment(s);

FIG. 3 illustrates example operations of a table structuring module according to one or more embodiment(s);

FIG. 4A illustrates an example table in an electronic document according to one or more embodiment(s);

FIG. 4B illustrates example text boxes and cell boxes according to one or more embodiment(s);

FIG. 4C illustrates an example table structuring operation according to one or more embodiment(s);

FIG. 4D illustrates an example structured table according to one or more embodiment(s);

FIG. 5 illustrates an example in which a table is structured by a table structuring operation according to one or more embodiment(s);

FIG. 6 illustrates example operations of a sub-table comparison module according to one or more embodiment(s);

FIG. 7 illustrates an example operation of generating a tree structure by recognizing a table according to one or more embodiment(s);

FIG. 8 illustrates an example operation of measuring a similarity between two tables according to one or more embodiment(s);

FIG. 9 is a flowchart illustrating an example table structuring operation of an electronic device according to one or more embodiment(s);

FIG. 10 is a flowchart illustrating an example operation in which an electronic device updates coordinate information about a plurality of cell boxes according to one or more embodiment(s); and

FIG. 11 is a flowchart illustrating an example operation of providing a confidence by an electronic device according to one or more embodiment(s).

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may refer to the same or similar elements throughout the specification and the drawings. Further, no description is made of well-known functions and configurations in the drawings and relevant descriptions.

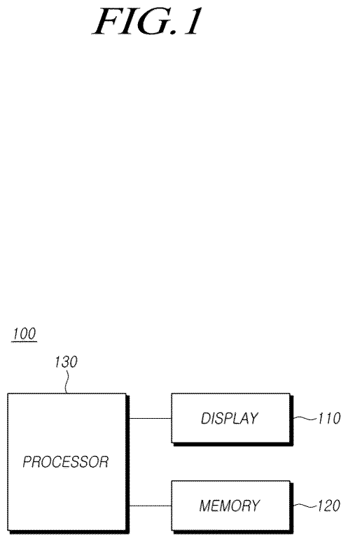

FIG. 1 is a block diagram illustrating an example electronic device according to one or more embodiment(s).

Referring to FIG. 1, the electronic device 100 includes a display 110, memory 120, and a processor 130. According to an embodiment, the electronic device 100 may include an additional component (e.g., a user interface or a transceiver) other than the illustrated components or may omit at least one of the illustrated components. According to an embodiment, the electronic device 100 may be any one of a mobile device (e.g., a smart phone or tablet), a computing device (e.g., a personal computer (PC) or a notebook), a wearable device (e.g., a smart watch or a head-mounted display (HMD)), or a home appliance (e.g., a TV), but is not limited thereto but may be various types of electronic devices.

According to an embodiment, the display 110 may perform various display operations according to functions of the electronic device 100. For example, the display 110 may display various types of information such as numbers, letters, images, graphics, or tables. The display 110 may be configured with a layer structure with a touch pad capability to form a touch screen. In this case, the display 110 may be used as an input interface as well as an output interface. The display 110 may be an independent display or may include a plurality of displays. The plurality of displays may be disposed at different positions.

According to an embodiment, the memory 120 may store various data used by at least one component (e.g., the display 110 or the processor 130) of the electronic device 100. For example, the memory 120 may store at least one program for processing and controlling the processor 130 and store input and/or output data. According to an embodiment, the memory 120 may store an artificial intelligence (AI) model (or a machine learning model or a deep learning model) and store data or information learned through the AI model. According to an embodiment, the memory 120 may include a volatile or non-volatile memory. According to an embodiment, a web storage or a cloud server that performs a storage function on the Internet may be operated by the electronic device 100.

According to an embodiment of the disclosure, the processor 130 may control the overall operation of the electronic device 100. The processor 130 may perform an operation or data processing related to control and/or communication of at least one other component of the electronic device 100. For example, the processor 130 may be electrically connected to the display 110, and the memory 120 and may execute instructions of a program stored in the memory 120.

The processor 130 may include a processing circuit that executes instructions of the program stored in the memory 120. The processor 130 may include at least one of a central processing unit (CPU), a neural processing unit (NPU), a graphics processing unit (GPU), a micro processing unit (MPU), a micro controller unit (MCU), an application processor (AP), a communication processor (CP), a system on chip (SoC), or an integrated circuit (IC) sensor hub, a supplementary processor, an application specific integrated circuit (ASIC), or a field programmable gate arrays (FPGA), and may include a plurality of cores.

The processor 130 may control the operations of the electronic device 100 by executing the instructions stored in the memory 120. For example, the processor 130 may correspond to a plurality of processors that divide (e.g., allocate) a plurality of operations between processors and collectively perform the operations. According to an embodiment, the processor 130 may perform the operations of the electronic device 100 described below.

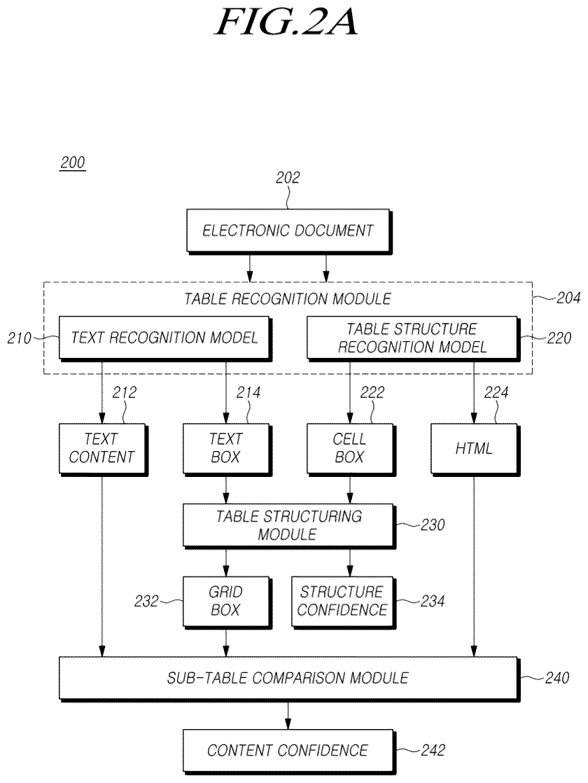

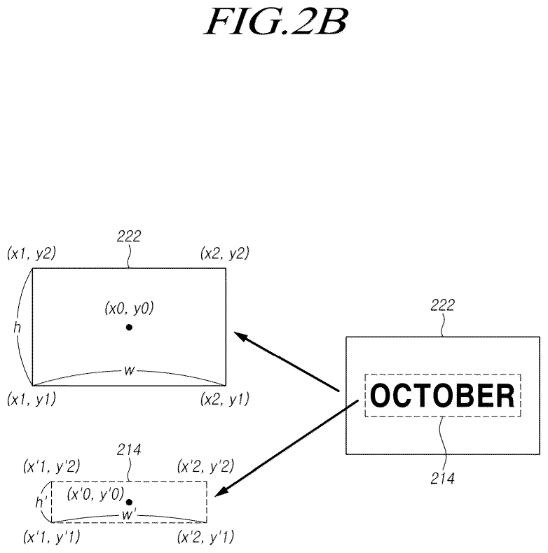

FIG. 2A illustrates an example table structuring device according to one or more embodiment(s).

According to an embodiment, the table structuring device 200 may be included in the processor 130 of the electronic device 100, a component corresponding to the processor 130, or an independent component that is electrically connected to the processor 130 to operate based on the control of the processor 130. In an embodiment, the table structuring device 200 is a computer code, computer codes, a computer program, computer programs stored or included in the memory 120. In the present disclosure, the table structuring device 200 may be replaced with a table structure code, table structure codes, a table structure program, or table structure programs.

Referring to FIG. 2A, the table structuring device 200 includes a table recognition module 204, a table structuring module 230, and a sub-table comparison module 240.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

In the present disclosure, the table recognition module 204 can be replaced with a table recognition code, table recognition codes, a table recognition program (software), or a table recognition processor (hardware). The table structuring module 230 can be replaced with a table structuring code, table structuring codes, a table structuring program (software), or a table structuring processor (hardware). The sub-table comparison module 240 can be replaced with a sub-table comparison code, sub-table comparison codes, a sub-table comparison program (software), or a sub-table comparison processor (hardware).

According to an embodiment, the table recognition module 204 may receive an electronic document 202. For example, the electronic document 202 may be in the form of an image and may include at least one table. A user may select the electronic document 202 from electronic documents stored in the electronic device 100. As an aspect of this disclosure, the electronic document 202 may be received from an external electronic device.

According to an embodiment, the table recognition module 204 may use an AI model that is trained (e.g., configured) for table recognition (e.g., identification or determination) based on (e.g., using) inputs of the electronic document 202. The AI model may be included in the electronic device 100 or in at least one server on a network. For example, the AI model is a neural network model, which may include a text recognition model 210 (that recognizes (e.g., identifies or determines) text included in the table) and a table structure recognition model 220 (that recognizes (e.g., identifies or determines) a structure of the table). The text recognition model 210 and the table structure recognition model 220 may be divided as illustrated in FIG. 2. In an embodiment, the text recognition model 210 and the table structure recognition model 220 may be one integrated model.

According to an embodiment, the text recognition model 210 may represent a model trained to recognize (e.g., identify or determine) text included in the image. For example, the text recognition model 210 may include an optical character recognition (OCR) model used to extract or recognize a visual form of text from the image.

According to an embodiment, the table recognition module 204 may identify the text content 212 and the text box 214 included in the electronic document 202. The text content 212 may represent the text included in the table of the electronic document 202. The text box 214 may represent a box area for identifying a boundary of text included in the table.

According to an embodiment, the table structure recognition model 220 may be trained to recognize (e.g., identify or determine) structural features of the table included in the image. The table structure recognition model 220 may identify at least one cell constituting the table, or rows and columns of the table.

According to an embodiment, the table recognition module 204 may obtain the cell box 222 and table structure information (e.g., a Hypertext Markup Language (HTML) document, hereinafter referred to as an ‘HTML document’) 224 included in the electronic document 202 based on the table structure recognition model 220.

According to an embodiment, the cell box 222 may represent a box area for determining the boundary (e.g., border) of the cell constituting the table. The cell box 222 may include one or more text boxes or no text box.

According to an embodiment, the HTML document 224 may define each cell of the table or each row and column of the table and structurally express (e.g., display) text included in each cell of the table or each row and column of the table using HTML tags. For example, the HTML tag may include <table>, <tr>, or <td>. <table> may define the start and end of the table. <tr> is positioned inside <table> and may represent the row of the table. <td> is positioned inside <table> and may represent the cell of the table including text. At least one of <table>, <tr>, and <td> may include various attributes indicating the structure or layout of the table. For example, <table> may include at least one of the following as attributes: border indicating the border thickness of the table, cellpadding indicating the margin between the boundary and content of each cell, cellspacing indicating the spacing between each cell, width indicating the width of the table, or height indicating the height of the table. For example, <tr> may include bgcolor attribute indicating the background color of the row. For example, <td> may include colspan attribute indicating how many columns the cell spans, or row span attribute indicating how many rows the cell spans.

According to an embodiment, the table structuring module 230 may obtain a structure confidence (or structural confidence) 234 for the recognized (e.g., identified or determined) table, and the sub-table comparison module 240 may obtain a content confidence 242. According to an embodiment, the structure confidence 234 may indicate a degree of match or similarity between the structural feature of the recognized table and the structural feature of the table in the electronic document 202. According to an embodiment, the content confidence 242 may indicate the degree of match or similarity between the text content included in the recognized table and the text content included in the table in the electronic document 202. In an embodiment, when the structure confidence 234 and the content confidence 242 are relatively higher (e.g., than threshold values), it can be determined (e.g., by the user) that the table recognition (e.g., identification or determination) is performed more accurately. In an embodiment, when the structure confidence 234 is relatively higher (e.g., than a threshold value), it can be determined (e.g., by the user) that the table recognition (e.g., identification or determination) is performed more accurately. In an embodiment, when the content confidence 242 is relatively higher (e.g., than a threshold value), it can be determined (e.g., by the user) that the table recognition (e.g., identification or determination) is performed more accurately.

According to an embodiment, information about the text box 214, obtained based on (e.g., from) the text recognition model 210, and the cell box 222, obtained based on (e.g. from) the table structure recognition model 220, may be inputs to the table structuring module 230. The table structuring module 230 may align the text box 214 and the cell box 222, and, based on the alignment result, generate the grid box 232 having a grid structure that divides cells, rows, or columns inside the table. The table structuring module 230 may use the alignment result as an index of the structure confidence 234 of the table.

According to an embodiment, the text content 212, obtained based on (e.g., from) the text recognition model 210, and the HTML document 224, obtained based on (e.g., from) the table structure recognition model 220, may be inputs to the sub-table comparison module 240. The sub-table comparison module 240 may be optionally used, and the consistency between the result of recognizing (e.g., identifying or determining) the entire table in the electronic document 202 and the result of recognizing (e.g., identifying or determining) a cut portion (e.g., a partial portion that is cut from the entire table) of the table may be used as an index of the content confidence 242.

According to an embodiment, the table structuring module 230 and the sub-table comparison module 240 may be configured independently or as one integrated module for use with the table recognition module 204 (or the text recognition model 210 and the table structure recognition model 220).

According to an embodiment, one of the table structuring module 230 or the sub-table comparison module 240 may be optional (e.g., not used). For example, the table structuring module 230 may not be used if the structure confidence 234 is not required, and the sub-table comparison module 240 may not be used if the content confidence 242 is not required. In order to increase the table recognition (e.g., identification or determination) speed, one of the table structuring module 230 and the sub-table comparison module 240 may not be used.

FIG. 2B illustrates example coordinate information about each of a cell box and a text box, according to one or more embodiment(s).

Referring to FIG. 2B, the cell box 222 indicates a box area for determining the boundary of the cell constituting the table. The cell box 222 may include one or more text boxes (e.g., the text box 214) or may not include any text box. According to an embodiment, the recognized (e.g., identified or determined) position of the cell box 222 in the electronic document 202 may be indicated as coordinate information. The coordinate information about the cell box 222 may be associated with a two-dimensional box area and may have (e.g., presented or provided in) various forms.

For example, the coordinate information about the cell box 222 may include (x1, y1), (x1, y2), (x2, y1), and (x2, y2) as coordinate information corresponding to each vertex of the cell box 222.

For example, the coordinate information about the cell box 222 may be in the form of (x1, y1, w, h) based on a reference point (or start point) (x1, y1) in the cell box 222. “w” represents the distance (e.g., length) from x1 on the x-axis and may indicate the width of the cell box 222 and also may may be used to determine x2. “h” represents the distance s (e.g., length) from y1 on the Y-axis and may indicate the height of the cell box 222 and may may be used to determine_y2.

For example, the coordinate information about the cell box 222 may be in the form of (x1, y1, x2, y2) that may indicate two coordinates (x1, x2) on the X-axis and two coordinates (y1, y2) on the Y-axis constituting the cell box 222.

According to an embodiment, the coordinate information about the cell box 222 may further include information about rows and columns. For example, if information about rows and/or columns, respectively, corresponding to the cell boxes 222 is output through the table structure recognition model 220 of the neural network, information about the row and the column may be added to the coordinate information, such as ([x1, y1, x2, y2], row, column).

According to an embodiment, the text box 214 may display a box area for identifying the boundaries (e.g., top, bottom, left, and right boundaries) of the text (e.g., OCTOBER), as shown in FIG. 2B. The text included in the text box 214 or the text included in the cell constituting the table may include at least one of a word, a sentence including spaces, or a paragraph including a line break.

According to an embodiment, the recognized (e.g., identified or determined) position of the text box 214 in the electronic document 202 may be indicated as coordinate information. The coordinate information about the text box 214 may include coordinate information associated with a two-dimensional box area and may have (e.g., presented or provided in) various forms.

For example, the coordinate information about the text box 214 may include (x′1, y′1), (x′1, y′2), (x′2, y′1), and (x′2, y′2) as coordinate information corresponding to each vertex of the text box 214.

For example, the coordinate information about the text box 214 may be in the form of (x′1, y′1, w′, h′) based on the reference point (or a start point) (x′1, y′1) in the text box 214. w′ represents the distance from x′1 on the X-axis and may indicate the width of the cell box 222 and may be used to determine x′2. h′ represents the distance from y′1 on the Y-axis, and may indicate the height of the text box 214, and may may be used to determine y′2.

For example, the coordinate information about the text box 214 may be in the form of (x′1, y′1, x′2, y′2) that may indicate two coordinates (x′1, x′2) on the X-axis and two coordinates (y′1, y′2) on the Y-axis constituting the text box 214.

According to an embodiment, the coordinate information about the cell box 222 may include central coordinate information or coordinate information corresponding to the zero point, such as (x0, y0). The coordinate information about the text box 214 may include central coordinate information or coordinate information corresponding to the zero point, such as (x′0, y′0). (x0, y0) and (x′0, y′0), and may allocate the text box 214 to the cell box 222 by measuring the distance between the cell box 222 and the text box 214. For example, if a plurality of text boxes adjacent to the cell box 222 are recognized (e.g., identified or determined), a text box (e.g., the text box 214) with the shortest distance from the cell box 222 among the plurality of text boxes may be allocated to the cell box 222. According to an embodiment, the distance between the cell box 222 and the text box 214 may be measured based on coordinate information (e.g., (x1, y1) and (x′1, y′1) other than (x0, y0) and (x′0, y′0).

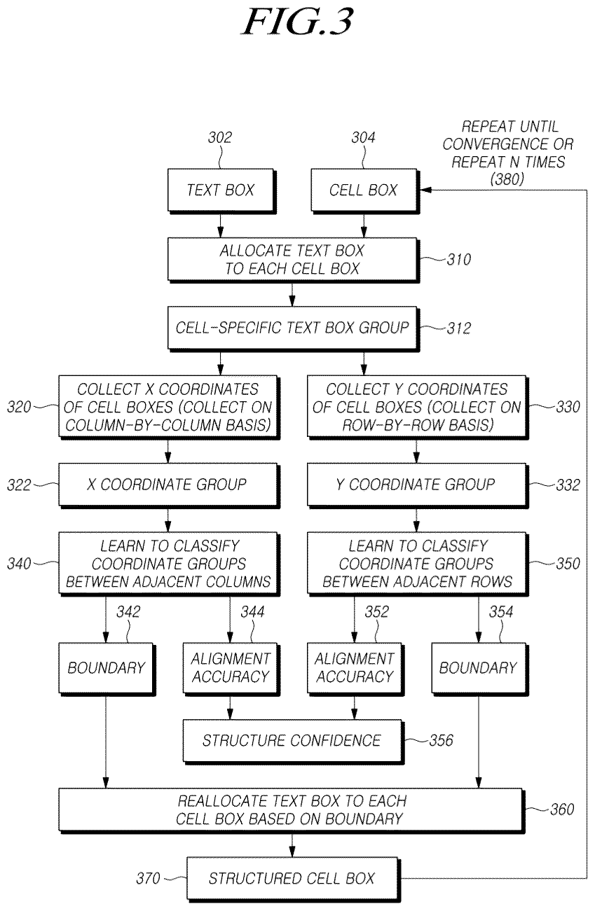

Hereinafter, the operation of the table structuring module 230 of FIG. 2A is described in detail with reference to FIG. 3.

FIG. 3 illustrates example operations of the table structuring module 230 according to one or more embodiment(s).

Referring to FIG. 3, the table structuring module 230 may identify the text box 302 and the cell box 304 in the electronic document 202 based on the information output from the table recognition module 204. According to an embodiment, there may be one or more text boxes, and there may be a plurality of cell boxes. Hereinafter, the text box 302 may be referred to as one or more text boxes 302, and the cell box 304 may be referred to as cell boxes 304.

In operation 310, the table structuring module 230 may allocate a text box to each cell box based on identifying one or more text boxes 302 and cell boxes 304. According to an embodiment, one or more text boxes 302 may include the text box 214 of FIGS. 2A and 2B, and the cell boxes 304 may include the cell box 222 of FIGS. 2A and 2B.

According to an embodiment, the table structuring module 230 may calculate the distance between each text box and each cell box based on coordinate information of each of the one or more text boxes 302 and coordinate information of each of the cell boxes 304. For example, the coordinate information of each of one or more text boxes 302 may be coordinate information (e.g., the coordinate information corresponding to the zero point of each text box) constituting each text box, and the coordinate information of each cell box 304 may be coordinate information (e.g., the coordinate information corresponding to the zero point of each cell box) constituting each cell box. The table structuring module 230 may identify at least one text box closest to at least one cell box among the one or more text boxes 302 and allocate the identified at least one text box to at least one cell box. A cell-specific text box group 312 may be formed based on at least one text box being allocated to the at least one cell box.

According to an embodiment, the table structuring module 230 may collect coordinates for the cell boxes 304 based on the formation of the cell-specific text box groups 312. For example, the table structuring module 230 may perform operations 320 and 330.

In operation 320, the table structuring module 230 may collect x-coordinates of the cell boxes 304 on a column-by-column basis based on coordinate information and row/column information (e.g., ([x1, y1, x2, y2], row, column)) about each of the cell boxes 304 output through the table structure recognition model 220. In operation 322, the table structuring module 230 may obtain an x coordinate group classified on a column-by-column basis.

In operation 330, the table structuring module 230 may collect y-coordinates of the cell boxes 304 on a row-by-row basis based on coordinate information and row/column information (e.g., ([x1, y1, x2, y2], row, column)) about each of the cell boxes 304 output through the table structure recognition model 220. In operation 332, the table structuring module 230 may obtain a y coordinate group classified on a row-by-row basis. Operation 320 and operation 330 may be performed simultaneously, or operation 330 may be performed prior to operation 320.

In operation 340, the table structuring module 230 may generate a decision boundary (hereinafter, referred to as a ‘column boundary’) 342 for separating adjacent columns in the x-coordinate group 322 classified on a column-by-column basis, based on a classification algorithm or a classification model (e.g., a support vector machine (SVM)). For example, the table structuring module 230 may generate the column boundary 342 for separating adjacent columns based on the x-coordinate of each of the adjacent columns. The table structuring module 230 may modify the x-coordinate of each of the adjacent columns so that the adjacent columns are aligned based on the column boundary 342. For example, the table structuring module 230 may modify the x-coordinate of each of the adjacent columns so that the x-coordinate of each of the adjacent columns correspond to the x-coordinate of the column boundary 342. In this case, one side of each of the adjacent cell boxes may have an x-coordinate corresponding to the column boundary 342, and the (enhanced, first) alignment accuracy 344 in the column direction may be obtained.

In operation 350, the table structuring module 230 may generate a decision boundary for separating adjacent rows in the y-coordinate group 322 classified on a row-by-row basis, based on a classification algorithm or a classification model (e.g., SVM). For example, the table structuring module 230 may generate a decision boundary (hereinafter referred to as a “row boundary”) 354 for separating adjacent rows based on the y-coordinate of each of the adjacent rows. The table structuring module 230 may modify the y-coordinate of each of the adjacent rows so that the adjacent rows are aligned based on the row boundary 354. For example, the table structuring module 230 may modify the y-coordinate of each of the adjacent rows so that the y-coordinate of each of the adjacent rows corresponds to the y-coordinate of row boundary 354. In this case, one side of each of the adjacent cell boxes may have a y-coordinate corresponding to the row boundary 354, and the (enhanced, second) alignment accuracy 352 in the row direction may be obtained.

According to an embodiment, the table structuring module 230 may calculate the structure confidence 356 based on the (first) alignment accuracy 344 in the column direction and the (second) alignment accuracy 352 in the row direction. The structure confidence 356 may represent a probability that the structural feature of the recognized (e.g., identified or determined) table matches the structural feature of the table in the electronic document 202, and a higher structure confidence 356 may indicate that table recognition (e.g., identification or determination) is performed more accurately. According to an embodiment, the structure confidence 356 may be calculated as shown in Equation 1 below.

$${p}_{i , j}^{struct} = Acc ( {col}_{i} ) * Acc ( {row}_{i} ) \qquad [ Equation 1 ]$$

Referring to Equation 1, i may represent the column index, and j may represent the row index. Acc(colᵢ) may indicate the alignment accuracy of the ith column, and Acc(rowⱼ) may indicate the alignment accuracy of the jth row.

$${p}_{i , j}^{struct}$$

may indicate the structure confidence of the table based on Acc(col) and Acc(rowⱼ) (or determined by the product of Acc(colᵢ) and Acc(rowⱼ)).

In operation 360, the table structuring module 230 may reallocate the text box to each cell box based on the boundary (e.g., the column boundary 342 and/or the row boundary 354). For example, the table structuring module 230 may identify at least one text box closest to each of the cell boxes 304 which have been modified in position and aligned based on the modification of the x- and y-coordinates of each of the cell boxes 304 and allocate the identified at least one text box to the corresponding cell box. The table structuring module 230 may generate a table including the structured cell boxes 304 by allocating at least one text box to each of the aligned cell boxes 304. The table structuring module 230 may display the generated table on the display (thus, providing the generated table to the user) and/or perform operation 302 and the subsequent operations.

According to an embodiment, the table structuring module 230 may repeatedly perform operation 302 and the subsequent operations until the structure confidence 356 converges to a set confidence (e.g., exceeding a threshold value) or repeatedly perform operation 302 and the subsequent operations by a predetermined number of times (e.g., N times, where N is 2, 3, 4, . . . ).

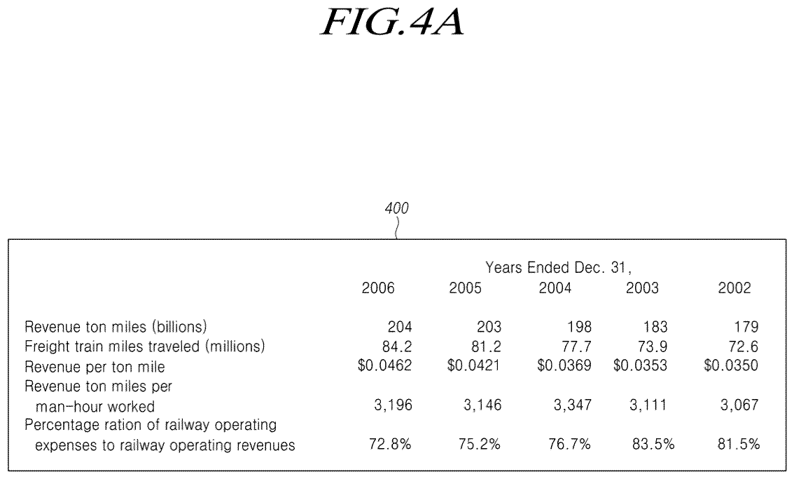

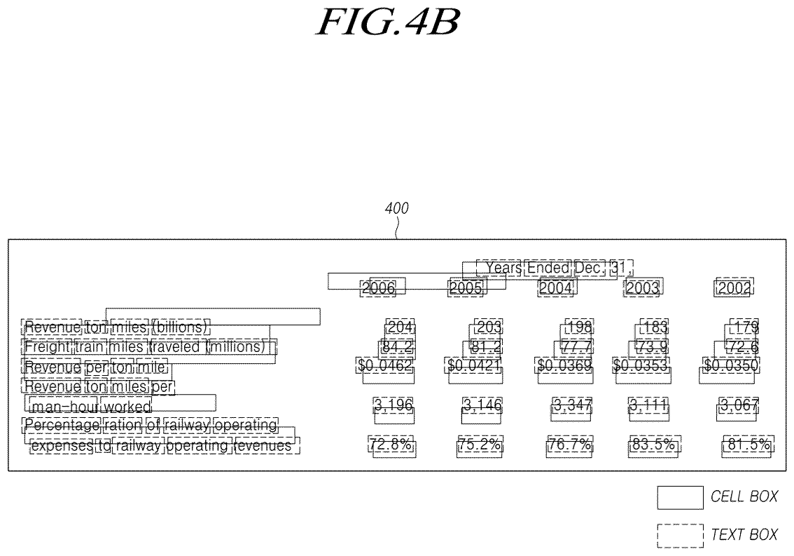

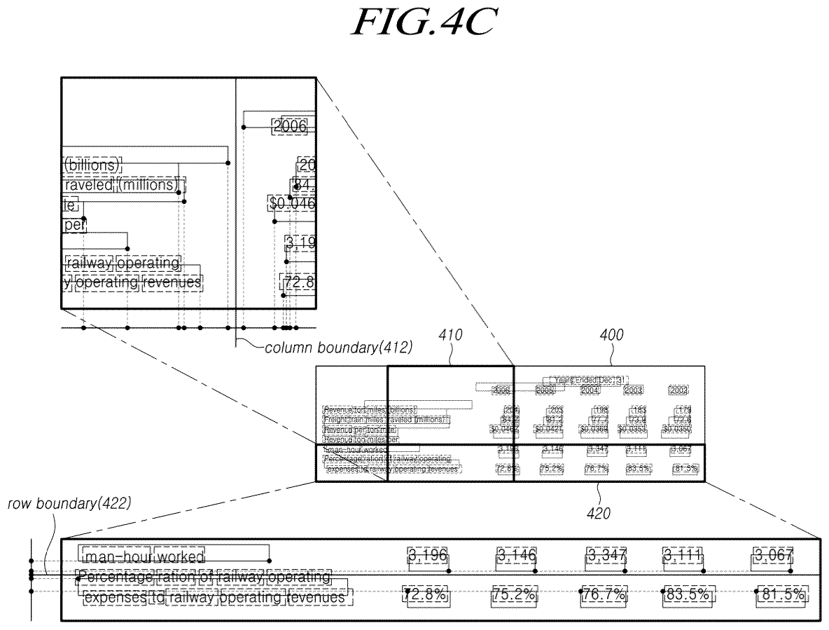

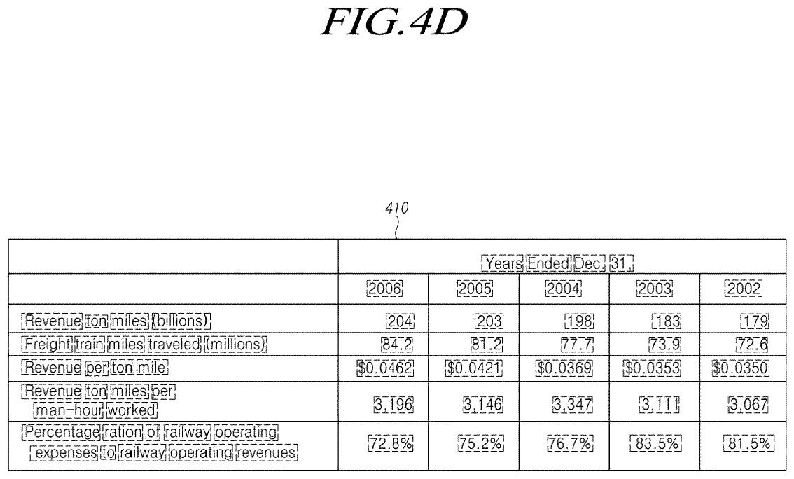

Hereinafter, operations of obtaining a structured table is described with reference to FIGS. 4A to 4D.

FIG. 4A illustrates an example table in an electronic document according to one or more embodiment(s).

Referring to FIG. 4A, an electronic document 202 may be an input to the table structuring device 200, and the table 400 may be included in the input electronic document 202. According to an embodiment, one or more tables may be included in the electronic document 202 and a table having a different shape, design, size, or number of row(s)/column(s) than the table 400 illustrated in FIG. 4A may be included.

According to an embodiment, the table structuring device 200 may identify the text boxes and cell boxes, included in the table 400, based on each of the text recognition model (e.g., the OCR model) 210 and the table structure recognition model 220, based on the input of the electronic document 202. For example, the table structuring device 200 may identify text boxes and cell boxes as illustrated in FIG. 4B.

FIG. 4B illustrates example text boxes and cell boxes according to one or more embodiment(s).

Referring to FIG. 4B, the table structuring device 200 may identify text boxes included in the table 400 based on the text recognition model 210. Each of the text boxes may be a box area for identifying the boundary of the text and may include text in a word, sentence, or paragraph unit, or may include spaces (e.g., spaces for line breaks).

The table structuring device 200 may identify cell boxes included in the table 400 based on the table structure recognition model 220. Each of the cell boxes is a box area for identifying the boundary of the cell constituting the table and may include one or more text boxes or may include no text box.

In FIG. 4B, the text boxes and the cell boxes may have shapes which are not aligned. The table structuring device 200 may perform a table structuring operation as illustrated in FIG. 4C so that text boxes and cell boxes are aligned to have a structured form.

FIG. 4C illustrates an example table structuring operation according to one or more embodiment(s).

Referring to FIG. 4C, the table structuring operation may be performed by the table structuring module 230 of the table structuring device 200. The table structuring module 230 may obtain coordinate information and row/column information (e.g., ([x1, y1, x2, y2], row, column)) about each of the cell boxes through the table structure recognition model 220 and may perform a grouping of the x-coordinates and y-coordinates of the cell boxes on a column-by-column basis and a row-by-row basis based on (e.g., using) the obtained information.

The table structuring module 230 may generate a column boundary for separating or dividing adjacent columns in the x coordinate group classified on a column-by-column basis based on a classification algorithm or a classification model (e.g., SVM). For example, the table structuring module 230 may generate a column boundary 412 so that x-coordinates of adjacent columns in the first portion 410 of the table 400 are separated (e.g., divided or determined).

The table structuring module 230 may modify x-coordinates on the left side and x-coordinates on the right side of the column boundary 412. For example, the table structuring module 230 may align the cell boxes to the position based on the column boundary 412 by modifying the x-coordinates on the left side of the column boundary 412 and x-coordinates on the right of the column boundary 412 to correspond to the x-coordinates of the column boundary 412. The table structuring module 230 may further generate a column boundary for the first portion 410 and another portion in a manner similar to the above-described method and may also perform an alignment operation on the additionally generated column boundary. Accordingly, the cell boxes may be aligned in the column direction.

The table structuring module 230 may generate a row boundary for separating or dividing adjacent rows in a y-coordinate group classified on a row-by-row basis based on a classification algorithm or a classification model (e.g., SVM). For example, the table structuring module 230 may generate a row boundary 422 so that the y-coordinates on the upper side and the y-coordinates on the lower side are separated (e.g., divided or determined) in the second portion 420 of the table 400.

The table structuring module 230 may modify y-coordinates on the upper side and y-coordinates on the lower side of the row boundary 422. For example, the table structuring module 230 may align the cell boxes to a position based on the row boundary 422 by modifying the y-coordinates on the upper side and the row boundary 422 on the lower side to correspond to the y-coordinates of the row boundary 422. The table structuring module 230 may further generate a row boundary for the second portion 420 and another portion in a manner similar to the above-described method and may also perform an alignment operation on the additionally generated row boundary. Accordingly, the cell boxes may be aligned in the row direction.

The table structuring module 230 may reallocate the text boxes based on the arrangement of the cell boxes in the column direction and/or the row direction. For example, the table structuring module 230 may identify at least one text box closest to each of the aligned cell boxes and reallocate the identified at least one text box to the corresponding cell box. According to an embodiment, the reallocated result may be as illustrated in FIG. 4D.

FIG. 4D illustrates an example structured table according to one or more embodiment(s).

Referring to FIG. 4D, the table structuring module 230 may generate the structured table 430 by displaying grid boxes having a grid structure that divides cells, rows, or columns based on the completion of the alignment operation for the cell boxes and the reallocation operation of the text boxes.

Since the structured table 430 illustrated in FIG. 4D has an aligned shape compared to the table 400 of FIG. 4B, the structure confidence may be high, and data may be analyzed more clearly visually.

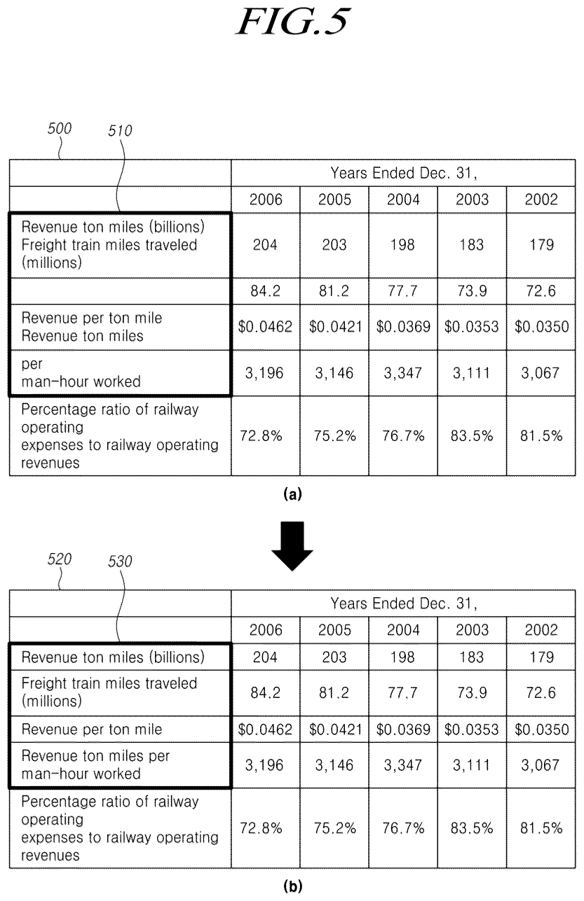

FIG. 5 illustrates an example in which a table is structured by a table structuring operation according to one or more embodiment(s).

Referring to FIG. 5(a), in the table 500 recognized (e.g., identified or determined) from the electronic document by the table structuring device 200, the positions of some cell boxes 510 may be inaccurately recognized (e.g., identified or determined) and thereby causing text boxes may be inaccurately allocated. For example, no text box may be allocated to one cell box, or a plurality of text boxes of one cell box may be allocated. In this case, data suitable for the item may not be mapped, and thus accuracy or confidence of the table 500 may be deteriorated. To prevent this error, the table structuring device 200 may use the table structuring module 230. According to an embodiment, the table structuring module 230 may perform a table structuring operation on the table 500 to generate a structured table 520 as illustrated in FIG. 5(b).

Referring to FIG. 5(b), the table structuring module 230 may generate a structured table 520 by aligning cell boxes (e.g., alignment in the column direction and/or row direction) and reallocating text boxes to the aligned cell boxes through the table structuring operation. When the table structuring operation is performed, some cell boxes 510 in the table 500 may be modified, similarly to some cell boxes 530 of the structured table 520, and the text boxes may be reallocated.

In some cell boxes 530 of the structured table 520, the text boxes may be accurately allocated per cell box, as compared to the table 500 illustrated in FIG. 5(a). Accordingly, data suitable for the item may be accurately mapped, so that the accuracy or confidence of the structured table 520 may be enhanced.

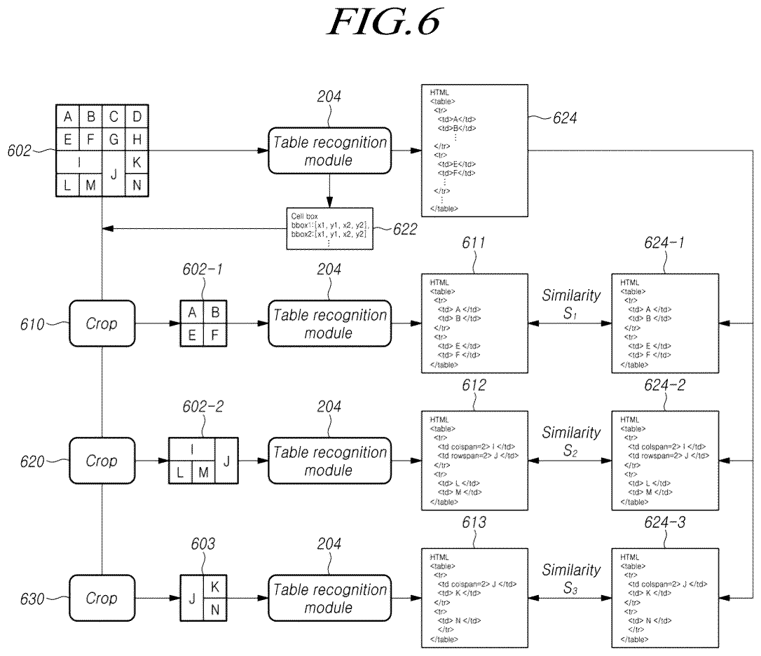

After the table structuring operation as described above is performed, a table recognition (e.g., identification or determination) result comparison operation for measuring content confidence may be performed. The table recognition (e.g., identification or determination) result comparison operation may be performed by the sub-table comparison module 240 described in connection with FIG. 2A. Hereinafter, the operation of the sub-table comparison module is described with reference to FIG. 6.

FIG. 6 illustrates example operations of a sub-table comparison module according to one or more embodiment(s).

Referring to FIG. 6, the sub-table comparison module 240, described in connection with FIG. 2A, may perform an operation of comparing the results of recognizing the table 602 in the electronic document 202 input to the table recognition module 204, and a user may have an option to use the sub-table comparison module 240. According to an embodiment, the sub-table comparison module 240 may compare the result of recognizing (e.g., identifying or determining) an entire portion of the table 602 by the table recognition module 204 with the result of recognizing (e.g., identifying or determining) a partial portion of the table 602 by the table recognition module 204.

The sub-table comparison module 240 may obtain the cell box information 622 and the first HTML document 624 as a result of recognizing (e.g., identifying or determining) the entire table 602 through the table recognition module 204.

The cell box information 622 may include coordinate information about each cell included in the table 602. For example, when N cell boxes are included in Table 602 (where N is a natural number of 2 or more), N cell boxes may be indicated as bbox 1 to bbox N, and the N cell boxes may correspond to the coordinate information of {x1, y1, x2, y2}. Here, x1, y1, x2, and y2 indicate two coordinates on the X-axis and two coordinates on the Y-axis constituting each cell box and may be set to different values for each cell box.

The first HTML document 624 may include tags indicating the entire structure of the table 602 (e.g., <table>, </table>, <tr>, </tr>, <td>, or </td>) and the full text (e.g., A, B, C, . . . , N).

The sub-table comparison module 240 may obtain at least one HTML document for comparison with the first HTML document 624 based on the cell box information 622 output from the table recognition module 204.

For example, the sub-table comparison module 240 may obtain a first portion 602-1 of the table 602 by performing a first crop operation 610, cutting a portion of the table 602 based on the cell box information 622. The sub-table comparison module 240 may obtain a second HTML document 611 which is a result of recognizing (e.g., identifying or determining) the first portion 602-1 through the table recognition module 204.

For example, the sub-table comparison module 240 may obtain a second portion 602-2 of the table 602 by performing a second crop operation 620, cutting a portion of the table 602 based on the cell box information 622. The sub-table comparison module 240 may obtain a third HTML document 612 which is a result of recognizing (e.g., identifying or determining) the second portion 602-2 through the table recognition module 204.

For example, the sub-table comparison module 240 may obtain a third portion 602-3 of the table 602 by performing a third crop operation 630, cutting a portion of the table 602 based on cell box information 622. The sub-table comparison module 240 may obtain a fourth HTML document 613 which is a result of recognizing (e.g., identifying or determining) the third portion 602-3 through the table recognition module 204.

According to an embodiment, the sub-table comparison module 240 may compare each of the second HTML document 611, the third HTML document 612, or the fourth HTML document 613 corresponding respectively to the result of recognizing (e.g., identifying or determining) each portion of the table 602 with the first HTML document 624 corresponding to the result of recognizing (e.g., identifying or determining) the whole of the table 602.

For example, the sub-table comparison module 240 may detect a first similarity s1 by comparing the second HTML document 611 with the portion 624-1 corresponding to the second HTML document 611 in the first HTML document 624.

For example, the sub-table comparison module 240 may detect a second similarity s2 by comparing the third HTML document 612 with the portion 624-2 corresponding to the third HTML document 612 in the first HTML document 624.

For example, the sub-table comparison module 240 may detect a third similarity s3 by comparing the fourth HTML document 613 with the portion 624-3 corresponding to the fourth HTML document 613 in the first HTML document 624.

According to an embodiment, the sub-table comparison module 240 may measure the content confidence based on the detected similarity, as illustrated in Equation 2.

$${p}_{i , j}^{contents} = \frac{1}{N} {\sum }_{{cell}_{i , j ∈ sub}} {s}_{sub} \qquad [ Equation 2 ]$$

In Equation 2, N represents the number of comparisons (e.g., the number of comparisons between the entire table and the portion of the table) for obtaining the similarity, cell_{i,j} represents the cell of the i-th column and the j-th row, sub represents the portion of the table, s_{sub} represents the similarity associated with the portion of the table, and

$${p}_{i , j}^{contents}$$

represents the content confidence.

According to an embodiment, the confidence of the table may be measured as illustrated in Equation 3 based on the structure confidence obtained based on Equation 1 and the content confidence obtained based on Equation 2.

$${p}_{i , j} = {p}_{i , j}^{structure} * {p}_{i , j}^{contents} \qquad [ Equation 3 ]$$

In Equation 3, p_{i,j} represents the confidence of the table determined based on

$${p}_{i , j}^{structure}$$

indicating the structure confidence and

$${p}_{i , j}^{contents}$$

indicating the content confidence.

According to an embodiment, the similarity (e.g., the first to third similarities) indicates how similar in structure and content (e.g., the text or text content) two tables are and may be obtained based on (e.g., using) various measurement methods. For example, the similarity may be obtained based on a similarity measurement method, such as “table edge distance based similarity” (“TEDS”).

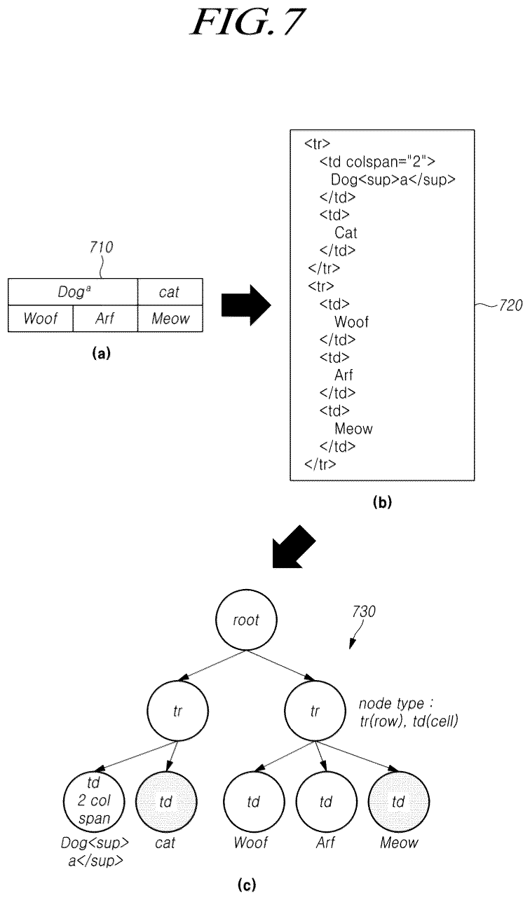

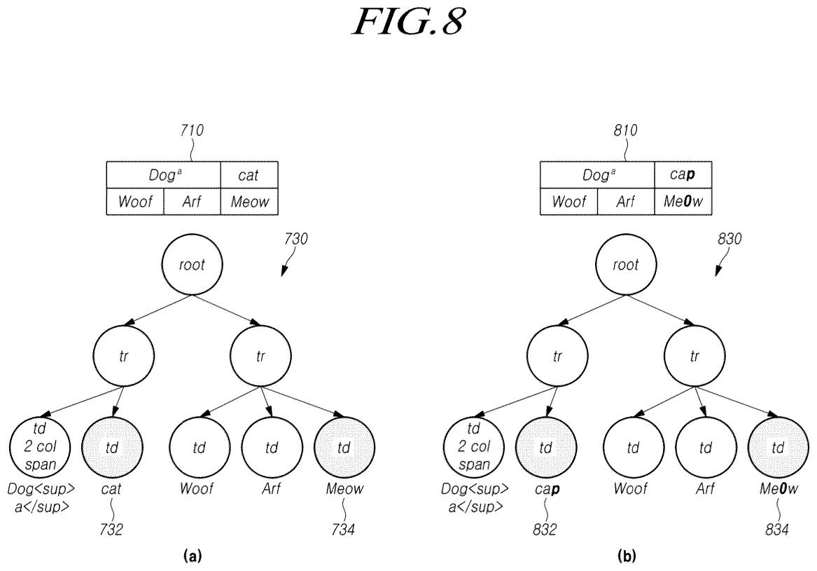

Hereinafter, a method of measuring the similarity using TEDS is described with reference to FIGS. 7 and 8.

FIG. 7 illustrates an example operation of generating a tree structure by recognizing a table according to one or more embodiment(s).

According to an embodiment, the table recognition module 204 may recognize (e.g., identify or determine) the table 710, as illustrated in FIG. 7(a), from the electronic document and output an HTML document (or HTML code) 720, as illustrated in FIG. 7(b). For example, the HTML document 720 may indicate tags indicating the cell structure of each row included in the table 710 and the text included in the cell of each row. The table recognition module 204 may input the HTML document 720 to the sub-table comparison module 240.

According to an embodiment, the sub-table comparison module 240 may generate a hierarchical tree structure 730 based on the HTML document 720. The tree structure 730 may include a root node, at least one row node, at least one cell node, or at least one text node.

According to an embodiment, in the HTML document 720, the table 710 (or the <table> tag indicating the table 710) may be set as the top root node in the tree structure 730.

According to an embodiment, the two <tr> tags representing two rows in the HTML document 720 may be set as row nodes or tr nodes that are sub nodes of the root node in the tree structure 730.

According to an embodiment, the <td> tags representing the cells included in each row in the HTML document 720 may be set as cell nodes or td nodes that are sub nodes of each row node in the tree structure 730. Each of the <td> tags may include a colspan indicating how many columns the cell extends corresponding to, or a rowspan indicating how many rows the cell extends corresponding to. For example, in the HTML document 720, <td colspan=“2”> may indicate a cell extended corresponding to two columns and may be included as “td 2 colspan” in the tree structure 730.

According to an embodiment, as shown in FIG. 7(a), the text (e.g., Dog^{a}, cat, Woof, Arf, and Meow) included in each cell node in the HTML document 720 may be set as a text node that is the lowest node in the tree structure 730. The text may include superscripts or subscripts. In the HTML document 720, the superscript may be indicated by a <sup> tag, and the subscript may be indicated by a <sub> tag. For example, “Dog^{a}” included in the table 710 may be included as “Dog<sup>a</sup>” in the HTML document 720 and the tree structure 730.

FIG. 8 illustrates an example operation of measuring a similarity between two tables according to one or more embodiment(s).

FIG. 8(a) illustrates a table 710 and a tree structure 730 as illustrated in FIG. 7 (hereinafter, referred to as a “first table 710” and a “first tree structure 730”, respectively), and FIG. 8(b) illustrates a second table 810 and a second tree structure 830.

According to an embodiment, the second table 810 may correspond to a result of recognizing (e.g., identifying or determining) a portion of the table, and the first table 710 may be a portion corresponding to the second table 810 in the result of recognizing (e.g., identifying or determining) the entire table. The second tree structure 830 is generated based on the second table 810 and may be generated in a method similar to the method described in connection with FIG. 7.

According to an embodiment, the similarity between the first table 710 and the second table 810 may be measured based on the first tree structure 730 and the second tree structure 830. For example, the similarity between the first table 710 and the second table 810 may be measured based on TEDS-based Equation 4 below.

$$TEDS ( {T}_{a} , {T}_{b} ) = 1 - \frac{EditDist ( {T}_{a} , {T}_{b} )}{max ( \vert {T}_{a} \vert , \vert {T}_{b} \vert )} \qquad [ Equation 4 ]$$

Referring to Equation 4, Tₐ indicates the tree structure (e.g., the first tree structure 730) of Table a (e.g., the first table 710), and T_{b} indicates the tree structure (e.g., the second tree structure 830) of Table b (e.g., the second table 810). EditDist(Tₐ, T_{b}) indicates the tree edit distance (or a normalized tree edit distance or OCR edit distance) between Tₐ and T_{b}. The tree edit distance is a numerical expression of an editing operation (e.g., insertion, deletion, or replacement) for matching texts with nodes of Tₐ and T_{b} other than the root node, and as the tree edit distance decreases, the similarity may increase. |Tₐ| indicates the number of nodes included in Tₐ, and |T_{b}| indicates the number of nodes included in T_{b}. max(|Tₐ|, |T_{b}|) indicates the maximum value out |Tₐ| of and |T_{b}|.

According to an embodiment, in the example illustrated in FIG. 8, the edit distance between the first table 710 and the second table 810 may be determined through comparison between nodes included in the first tree structure 730 and nodes included in the second tree structure 830. As a result of the comparison, the first tree structure 730 and the second tree structure 830 have the same structure but may include partially different text. For example, cat 730 and Meow 734 included in the first tree structure 730 may differ from cap 832 and Me0w 834 included in the second tree structure 830, and an editing operation (e.g., a replacement operation) needs to be performed on the second tree structure 830 to match them.

According to an embodiment, the editing operation on the second tree structure 830 may be performed for each of two node groups divided into tr nodes except for the root node. The two node groups may include a first node group including a tr node and two td nodes, and a second node group including a tr node and three td nodes.

Since cap 832 included in one of the three nodes included in the first node group should be corrected to cat 730, the tree edit distance may be determined as ⅓ based on the total number (e.g., 3) of nodes and the number (e.g., 1) of edit nodes.

Since Me0w 834 included in one of the four td nodes included in the second node group should be corrected to Meow 734, the tree edit distance may be determined as ¼ based on the total number (e.g., 4) of nodes and the number (e.g., 1) of edit nodes.

As a result, the tree edit distance between the table 710 and the second table 810 corresponding to EditDist(Tₐ, T_{b}) may be determined as

$$\frac{1}{3} + \frac{1}{4} .$$

According to an embodiment, since the first tree structure 730 and the second tree structure 830 each includes seven nodes, the maximum number of nodes corresponding to max (|Tₐ|), |T_{b}|) may be determined as 7.

$$\frac{1}{3} + \frac{1}{4}$$

Based on the above-described tree edit distance and the maximum number of nodes which is 7, the similarity TEDS between the first table 710 and the second table 810 may be determined as illustrated in Equation 5 below.

$$TEDS = 1 - ( \frac{1}{3} + \frac{1}{4} ) \times \frac{1}{7} \qquad [ Equation 5 ]$$

According to an embodiment, the similarity based on TEDS may be determined as a set range value (e.g., a value between 0 and 1), and the value closer to 1 may indicate the higher similarity.

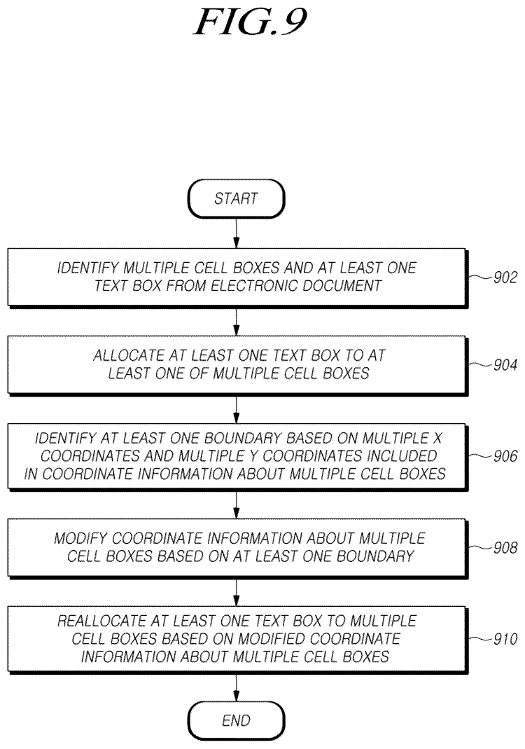

Hereinafter, operations of the electronic device 100 are described in detail with reference to FIGS. 9 to 11. According to an embodiment, the operations illustrated in FIGS. 9 to 11 are performed by the processor 130 of the electronic device 100. The operations illustrated in each of FIGS. 9 to 11 are not limited to the illustrated order but may be performed in various orders. According to an embodiment, at least some of the operations illustrated in each of FIGS. 9 to 11 may be omitted, or more operations may be performed than those illustrated in each of FIGS. 9 to 11.

FIG. 9 is a flowchart illustrating an example table structuring operation of an electronic device according to one or more embodiment(s).

Referring to FIG. 9, in operation 902, the electronic device 100 may identify a plurality of cell boxes and at least one text box from an electronic document (e.g., the electronic document 202 of FIG. 2). According to an embodiment, the electronic device 100 may identify a plurality of cell boxes and at least one text box based on an AI model (e.g., the text recognition model 210 and the table structure recognition model 220 of FIG. 2) trained for table recognition (e.g., identification or determination).

According to an embodiment, the plurality of cell boxes may represent box areas for identifying boundaries of the plurality of cells constituting the table in the electronic document.

According to an embodiment, at least one text box may include text included in the table of the electronic document and may represent the box area for identifying the boundary of the text. The text included in the at least one text box may include at least one of a word, a sentence including spaces, or a paragraph including a line break.

In operation 904, the electronic device 100 may allocate at least one text box to at least one of the plurality of cell boxes. According to an embodiment, at least one text box allocated to at least one cell box may include a text box closest to at least one cell box. At least one other cell box among the plurality of cell boxes may include no text box when there is no adjacent text box within a predetermined distance.

In operation 906, the electronic device 100 may identify at least one boundary based on a plurality of x-coordinates and a plurality of y-coordinates included in coordinate information about the plurality of cell boxes. According to an embodiment, at least one boundary may include a boundary (e.g., the column boundary 412 and/or the row boundary 422 of FIG. 4C) for separating rows or columns of the table.

In operation 908, the electronic device 100 may modify coordinate information about the plurality of cell boxes based on at least one boundary.

In operation 910, the electronic device 100 may reallocate at least one text box to the plurality of cell boxes based on the modified coordinate information about the plurality of cell boxes. According to an embodiment, the operation of reallocating at least one text box to the plurality of cell boxes may include the operation of allocating at least one text box closest to each of the plurality of cell boxes based on modified coordinate information about the plurality of cell boxes and coordinate information about the at least one text box. Text boxes may be or may not be included in each of the plurality of cell boxes after reallocation, and cell boxes including each text box before and after reallocation may be the same or different.

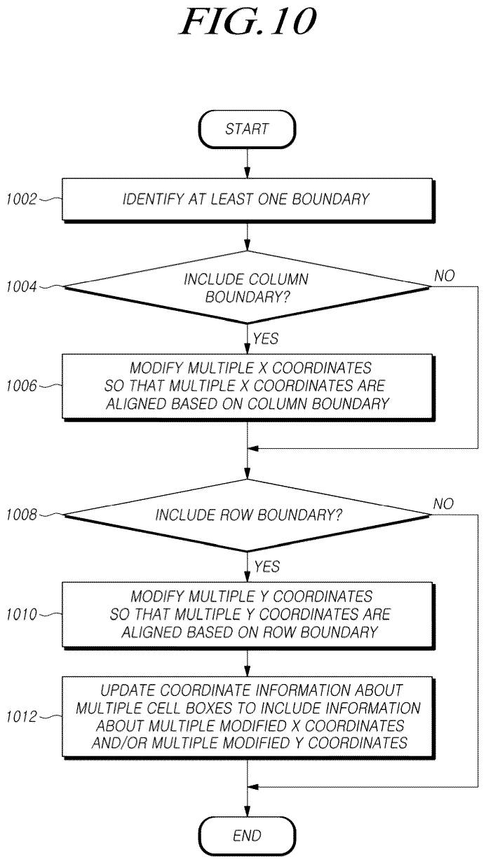

FIG. 10 is a flowchart illustrating an example operation in which an electronic device updates coordinate information about a plurality of cell boxes according to one or more embodiment(s).

According to an embodiment, the operations illustrated in FIG. 10 may be detailed operations of operation 908 of FIG. 9.

Referring to FIG. 10, in operation 1002, the electronic device 100 may identify at least one boundary.

In operation 1004, the electronic device 100 may determine whether a column boundary (e.g., the column boundary 412 of FIG. 4C) is included in at least one boundary. According to an embodiment, the column boundary may be generated to separate (e.g., divide or identify) the columns included in the table based on a classification algorithm or a classification model (e.g., SVM).

In operation 1006, the electronic device 100 may modify the plurality of x-coordinates so that the plurality of x-coordinates associated with the plurality of cell boxes are aligned based on the column boundary based on the column boundary being included in the at least one boundary. For example, the electronic device 100 may modify the plurality of x-coordinates so that one side of adjacent cell boxes with respect to the column boundary corresponds to the column boundary.

In operation 1008, the electronic device 100 may determine whether at least one boundary includes a row boundary (e.g., the row boundary 422 of FIG. 4C) based on the at least one boundary not including the column boundary or operation 1006 being performed. According to an embodiment, the row boundary may be generated to separate the rows included in the table based on a classification algorithm or a classification model (e.g., SVM).

In operation 1010, the electronic device 100 may modify the plurality of y-coordinates so that the plurality of y-coordinates associated with the plurality of cell boxes are aligned based on the row boundary based on the row boundary being included in the at least one boundary. For example, the electronic device 100 may modify the plurality of x-coordinates so that one side of adjacent cell boxes with respect to the row boundary corresponds to the row boundary.

In operation 1012, the electronic device 100 may update coordinate information about the plurality of cell boxes to include information about the plurality of modified x-coordinates and/or the plurality of modified y-coordinates.

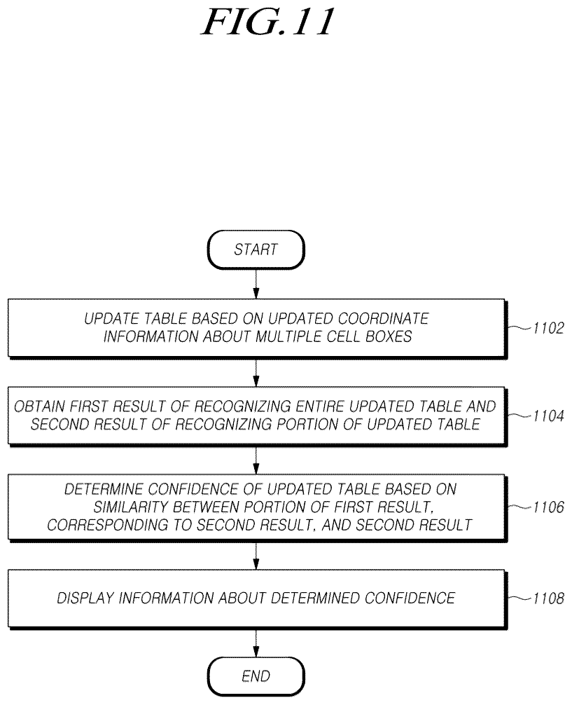

FIG. 11 is a flowchart illustrating an example operation of providing a confidence by an electronic device according to one or more embodiment(s).

According to an embodiment, the operations illustrated in FIG. 11 may be performed after the operations of FIG. 9.

Referring to FIG. 11, in operation 1102, the electronic device 100 may perform table update based on updated coordinate information about the plurality of cell boxes. According to an embodiment, the electronic device 100 may perform table update by displaying a grid box having a grid structure based on the updated coordinate information about the plurality of cell boxes and reallocating at least one text box to the closest cell box among the plurality of cell boxes.

In operation 1104, the electronic device 100 may obtain a first result of recognizing (e.g., identifying or determining) the entire updated table and a second result of recognizing (e.g., identifying or determining) a portion of the updated table.

In operation 1106, the electronic device 100 may determine the confidence of the updated table based on the degree of similarity between the portion corresponding to the second result in the first result and the second result. According to an embodiment, when there is a plurality of results of recognizing (e.g., identifying or determining) a portion of the updated table, the electronic device 100 may repeatedly perform operations 1104 and 1106.

In operation 1108, the electronic device 100 may display information about the determined confidence on the display 110. For example, the electronic device 100 may display confidence information through a notification window or display the portion where the confidence is below or above a threshold in the table, in various forms (e.g., an icon or a message display, or a graphic form). Based on the displayed confidence information, the user may conveniently determine whether to utilize the table recognition (e.g., identification or determination) result according to (or based on) the confidence.

One or more embodiments of the disclosure and the terms used therein are not intended to limit the technological features set forth herein to particular embodiments and include various changes, equivalents, or replacements for a corresponding embodiment. With regard to the description of the drawings, similar reference numerals may refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., through a wire or wires), wirelessly, or via a third element.

According to one or more embodiments, each component (e.g., a module or a program) of the above-described components may include a single entity or multiple entities. Some of the plurality of entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions; and
at least one processor configured to execute the instructions,
wherein the instructions, when executed by the at least one processor individually or collectively, cause the electronic device to:
identify, from an electronic document, a plurality of cell boxes included in a table and at least one text box included in the table, wherein each of the at least one text box includes text;
allocate each of the at least one text box to a first corresponding cell box among the plurality of cell boxes, based on first coordinate information about the plurality of cell boxes and second coordinate information about the at least one text box;
identify at least one boundary for separating rows or columns of the table, based on a plurality of x-coordinates and a plurality of y-coordinates that are included in the first coordinate information about the plurality of cell boxes;
modify the first coordinate information about the plurality of cell boxes, based on the at least one boundary; and
reallocate each of the at least one text box to a second corresponding cell box among the plurality of cell boxes, based on the modified first coordinate information about the plurality of cell boxes.

2. The electronic device of claim 1, wherein the at least one text box indicates at least one box area for identifying boundaries of each text included respectively in the at least one text box, and
wherein the plurality of cell boxes indicate box areas for identifying boundaries of a plurality of cells included in the table.

3. The electronic device of claim 1, wherein each text included respectively in the at least one text box comprises at least one of one or more words, one or more sentences including at least one space, or one or more paragraphs including at least one line break.

4. The electronic device of claim 1, wherein the instructions, when executed by the at least one processor individually or collectively, cause the electronic device to allocate one or more text boxes, which are most adjacent to the first corresponding cell box, to the first corresponding cell box, wherein the allocated one or more text boxes are included in the at least one text box.

5. The electronic device of claim 1, wherein the instructions, when executed by the at least one processor individually or collectively, cause the electronic device to obtain information about the at least one boundary using a pre-trained classification model, based on the plurality of x-coordinates and the plurality of y-coordinates.

6. The electronic device of claim 1, wherein the instructions, when executed by the at least one processor individually or collectively, cause the electronic device to:
modify the plurality of x-coordinates to align the plurality of x-coordinates based on at least one first boundary based on the at least one boundary including the at least one first boundary for separating the columns of the table; and
updates the first coordinate information about the plurality of cell boxes to include information about the plurality of modified x-coordinates.

7. The electronic device of claim 1, wherein the instructions, when executed by the at least one processor individually or collectively, cause the electronic device to:
modify the plurality of y-coordinates to align the plurality of y-coordinates based on at least one second boundary based on the at least one boundary including the at least one second boundary for separating the rows of the table; and
updates the first coordinate information about the plurality of cell boxes to include information about the plurality of modified y-coordinates.

8. The electronic device of claim 1, wherein the instructions, when executed by the at least one processor individually or collectively, cause the electronic device to:
modify the plurality of x-coordinates to align the plurality of x-coordinates based on at least one first boundary based on the at least one boundary including the at least one first boundary for separating the columns of the table;
modify the plurality of y-coordinates to align the plurality of y-coordinates based on at least one second boundary based on the at least one boundary including the at least one second boundary for separating the rows of the table; and
update the first coordinate information about the plurality of cell boxes to include information about the plurality of modified x-coordinates and information about the plurality of modified y-coordinates.

9. The electronic device of claim 1, further comprising a display,
wherein the instructions, when executed by the at least one processor individually or collectively, cause the electronic device to:
update the table based on reallocating each of the at least one text box to the second corresponding cell box among the plurality of cell boxes;
obtain a first result of recognizing a whole of the updated table and a second result of recognizing a first portion of the updated table;
determine a confidence of the updated table based on a similarity between a second portion of the first result, which corresponds to the first portion, and the second result; and
display, on the display, information about the determined confidence.

10. The electronic device of claim 9, wherein the instructions, when executed by the at least one processor individually or collectively, cause the electronic device to display, on the display, information indicating that the first portion of the updated table has a confidence of a threshold or less, based on the determined confidence being the threshold or less.

11. A method for operating an electronic device, the method comprising:
identifying, from an electronic document, a plurality of cell boxes in a table and at least one text box in the table, wherein each of the at least one text box comprises text;
allocating each of the at least one text box to a first corresponding cell box among the plurality of cell boxes, based on first coordinate information about the plurality of cell boxes and second coordinate information about the at least one text box;
identifying at least one boundary for separating rows or columns of the table, based on a plurality of x-coordinates and a plurality of y-coordinates that are included in the first coordinate information about the plurality of cell boxes;
modifying the first coordinate information about the plurality of cell boxes, based on the at least one boundary; and
reallocating each of the at least one text box to a second corresponding cell box among the plurality of cell boxes, based on the modified first coordinate information about the plurality of cell boxes.

12. The method of claim 11, wherein the at least one text box indicates at least one box area for identifying boundaries of each text included respectively in the at least one text box, and
wherein the plurality of cell boxes indicate box areas for identifying boundaries of a plurality of cells in the table.

13. The method of claim 11, wherein each text included respectively in the at least one text box comprises at least one of one or more words, one or more sentences including at least one space, or one or more paragraphs including at least one line break.

14. The method of claim 11, wherein the allocating the at least one text box comprises allocating one or more text boxes, which are most adjacent to the first corresponding cell box, to the first corresponding cell box, wherein the allocated one or more text boxes are included in the at least one text box.

15. The method of claim 11, wherein the identifying the at least one boundary comprises:
obtaining information about the at least one boundary using a pre-trained classification model based on the plurality of x-coordinates and the plurality of y-coordinates; and
identifying the at least one boundary based on the obtained information about the at least one boundary.

16. The method of claim 11, wherein the modifying the first coordinate information about the plurality of cell boxes comprises:
align, based on at least one first boundary, the plurality of x-coordinates by modifying the plurality of x-coordinates based on the at least one boundary comprising the at least one first boundary for separating the columns of the table; and
updating the first coordinate information about the plurality of cell boxes to comprise information about the plurality of x-coordinates that are modified.

17. The method of claim 11, wherein the modifying the first coordinate information about the plurality of cell boxes comprises:
align, based on at least one second boundary, the plurality of y-coordinates by modifying the plurality of y-coordinates based on the at least one boundary comprising the at least one second boundary for separating the rows of the table; and
updating the first coordinate information about the plurality of cell boxes to comprise information about the plurality of y-coordinates that are modified.

18. The method of claim 11, wherein the modifying the first coordinate information about the plurality of cell boxes comprises:
aligning, based on at least one first boundary, the plurality of x-coordinates by modifying the plurality of x-coordinates based on the at least one boundary comprising the at least one first boundary for separating the columns of the table;
aligning, based on at least one second boundary, the plurality of y-coordinates by modifying the plurality of y-coordinates based on the at least one boundary comprising the at least one second boundary for separating the rows of the table; and
updating the first coordinate information about the plurality of cell boxes to include information about the plurality of x-coordinates that are modified and information about the plurality of y-coordinates that are modified.

19. The method of claim 11, further comprising:
updating the table based on reallocating each of the at least one text box to the second corresponding cell box among the plurality of cell boxes;
obtaining a first result of recognizing a whole of the updated table and a second result of recognizing a first portion of the updated table;
determining a confidence of the updated table based on a similarity between a second portion of the first result, which corresponds to the first portion, and the second result; and
displaying information about the determined confidence.

20. The method of claim 19, further comprising displaying, on a display, information indicating that the portion of the updated table has a confidence of a threshold or less, based on the determined confidence being the threshold or less.
